(19) United States
(12) Patent Application Publication
(10) Pub. No.: US 2014/0317334 A1
(43) Pub. Date: Oct. 23, 2014

(54) STORAGE OF GATE TRAINING PARAMETERS FOR DEVICES UTILIZING RANDOM ACCESS MEMORY

(71) Applicant: LSI Corporation, San Jose, CA (US)

(72) Inventor: Sagar G. Gadsing, Colorado Springs, CO (US)

(73) Assignee: LSI CORPORATION, San Jose, CA (US)

(21) Appl. No.: 13/894,836

(22) Filed: May 15, 2013

Related U.S. Application Data
(60) Provisional application No. 61/814,567, filed on Apr. 22, 2013.

(51) Int. Cl. G06F 3/06

(52) U.S. Cl. CPC G06F 3/0604; G06F 3/0653; G06F 3/0685
USPC 711/103; 711/104; 711/105

(57) ABSTRACT

Methods and structure are provided for maintaining gate training parameters for Random Access Memory. The system comprises a memory controller and a management unit. The management unit is able to initialize the system after the system returns from an unpowered state by accessing a non-volatile memory to retrieve timing intervals for electrical impulses sent between the memory controller and a Random Access Memory. The timing intervals previously enabled communication between the memory controller and the Random Access Memory. The management unit is further able to initialize the system after the system returns from an unpowered state by calibrating the memory controller to enable communication with the Random Access Memory based on the retrieved timing intervals.

### CROSS REFERENCE TO RELATED APPLICATIONS

This document claims priority to U.S. Provisional Patent Application No. 61/814,567 (filed on Apr. 22, 2013) entitled STORAGE OF GATE TRAINING PARAMETERS FOR DEVICES UTILIZING RANDOM ACCESS MEMORY, which is hereby incorporated by reference.

### FIELD OF THE INVENTION

The invention relates generally to circuitry that utilizes Random Access Memory (RAM), and more specifically to training parameters for RAM used by a circuit.

### BACKGROUND

When a circuit is initially powered on, some parameters describing the physical properties of RAM are retrieved in a process known as Serial Presence Detection (SPD). However, electrical timing parameters for reading from and/or writing to the RAM are circuit-specific. Such timing parameters are calibrated in a process known as “gate training.” For example, gate training may be used to determine a read and/or write leveling delay for accessing the RAM via a memory controller. Write leveling for RAM refers to matching the timing of DQS and CLK signals so that data is correctly read from the RAM. During gate training, the memory controller iterates through many different values for each timing parameter, until it finds values that allow the circuitry of the memory controller to reliably access the RAM. These timing parameters vary as a function of circuit operating temperature, the specific type of RAM being used, the layout of the circuit itself, and other factors. Because of this, each time the circuit is powered on, the memory controller performs gate training to identify the appropriate timing parameters to communicate with the RAM.

### SUMMARY

Systems and methods herein are capable of speeding up the gate training process by storing timing intervals that were previously used by a memory controller to communicate with RAM. Using these stored timing intervals as a starting point for the training process whenever the system initializes can substantially increase the startup speed of the system. This in turn helps the system to reach operational status more quickly.

One exemplary embodiment is a system for maintaining gate training parameters for Random Access Memory. The system comprises a memory controller and a management unit. The management unit is able to initialize the system after the system returns from an unpowered state by accessing a non-volatile memory to retrieve timing intervals for electrical impulses sent between the memory controller and a Random Access Memory. The timing intervals previously enabled communication between the memory controller and the Random Access Memory. The management unit is further able to initialize the system after the system returns from an unpowered state by calibrating the memory controller to enable communication with the Random Access Memory based on the retrieved timing intervals.

Other exemplary embodiments (e.g., methods and computer readable media relating to the foregoing embodiments) are also described below.

### BRIEF DESCRIPTION OF THE FIGURES

Some embodiments of the present invention are now described, by way of example only, and with reference to the accompanying figures. The same reference number represents the same element or the same type of element on all figures.

FIG. 1 is a block diagram of an exemplary electronic device.

FIG. 2 is a flowchart describing an exemplary method to operate an electronic device to calibrate RAM.

FIG. 3 is a block diagram of an exemplary multi-path interface between a memory controller and RAM.

FIG. 4 is a block diagram of an exemplary storage controller operating within a storage system.

FIG. 5 illustrates an exemplary processing system operable to execute programmed instructions embodied on a computer readable medium.

### DETAILED DESCRIPTION OF THE FIGURES

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below, but by the claims and their equivalents.

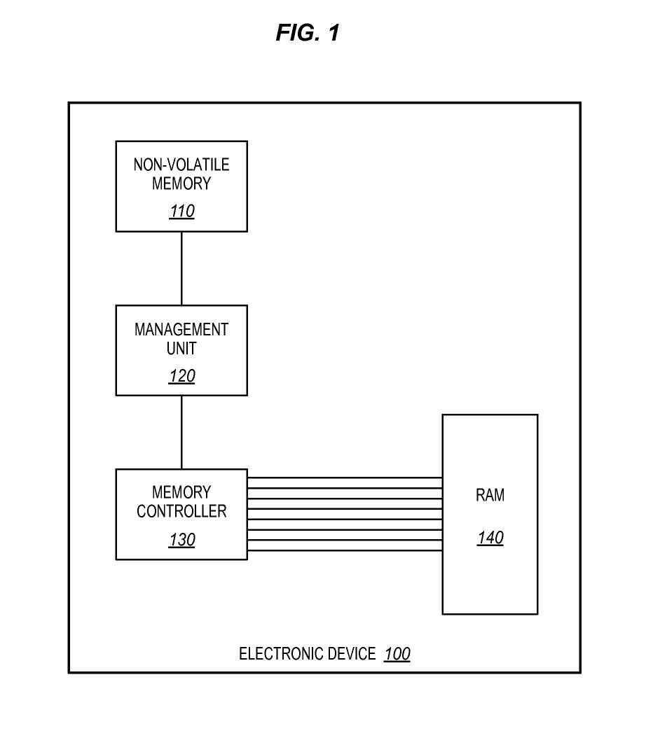

FIG. 1 is a block diagram of an exemplary electronic device 100. In one embodiment, electronic device 100 is a storage controller of a storage system. Upon receiving power, electronic device 100 initializes to calibrate physical layer parameters for its circuitry components, including memory controller 130. During this initialization, a gate training process is used to enable memory controller 130 to access Random Access Memory (RAM) 140. The gate training process determines timing intervals for electrical impulses sent between memory controller 130 and RAM 140.

Electronic device 100 stores previously used (i.e., previously acceptable) timing intervals for gate training in non-volatile memory 110. These stored timing intervals can be used for gate training the next time electronic device 100 initializes, in order to speed up and/or entirely bypass the training process for memory controller 130. Reducing the length of the gate training process makes RAM 140 become available for processing much more quickly.

Management unit 120 controls the operations of electronic device 100 during initialization and gate training. Specifically, management unit 120 calibrates physical layer electrical parameters for the various hardware components of electronic device 100, in order to allow higher layers at electronic device 100 (e.g., a link layer, a transport layer, an application layer, etc.) to function.

Management unit 120 may be implemented as custom circuitry, a processor executing programmed instructions stored in firmware memory, or some combination thereof. In any case, management unit 120 is capable of initializing gate training for communications between memory controller 130 and RAM 140 (e.g., even before a Basic Input Output System (BIOS) for electronic device 100 has started to operate). As a part of this process, management unit 120 acquires gate training timing intervals for memory controller 130 from non-volatile memory 110, and uses these stored timing intervals to speed up gate training for memory controller 130. These timing intervals indicate delays and/or other timing characteristics for signals sent to and/or received along physical communication pathways between memory controller 130 and RAM 140.

Unlike RAM 140, non-volatile memory 110 does not require an initial training period. Therefore, the data stored in non-volatile memory 110 can be retrieved before initialization of electronic device 100 has completed. In one embodiment non-volatile memory 110 comprises an Electrically Erasable Programmable Read-Only Memory (EEPROM) that stores a Serial Boot Record (SBR) accessible by management unit 120. Such an EEPROM may provide data over a two wire serial interface.

Memory controller 130 is used to establish physical layer communications with RAM 140. Memory controller 130 comprises a circuit with gates that are used to access one or more communication pathways to communicate with RAM 140. In one embodiment, the communication pathways are paired electrical lines that utilize differential voltages in order to communicate digital information.

RAM 140 comprises any suitable form of Random Access Memory, such as Dynamic RAM (DRAM), Static RAM (SRAM), etc. During operation, RAM 140 may be used by electronic device 100 in order to (temporarily) store data in a low-latency, high throughput format. This in turn can increase the performance of electronic device 100. For example, in one embodiment, RAM 140 is used as a cache memory at electronic device 100 in order to increase the speed at which data is stored or retrieved by electronic device 100.

Once gate training has completed and acceptable timing intervals have been determined for memory controller 130, management unit 120 can store the current gate-trained timing intervals in non-volatile memory 110. Management unit 120 can, for example, store the current timing intervals immediately after initialization, or after detecting a signal indicating that electronic device 100 will be powered down shortly in the future (e.g., a power-down signal received during a pending shutdown of a computer system). Management unit 120 can further hand off control to a general purpose processor within electronic device 100 once initialization of the physical layer (or initialization of memory controller 130) is complete. Alternatively, after initialization management unit 120 can operate within electronic device 100 in order to perform the primary intended tasks of electronic device 100.

The particular arrangement, number, and configuration of components described herein is exemplary and non-limiting.

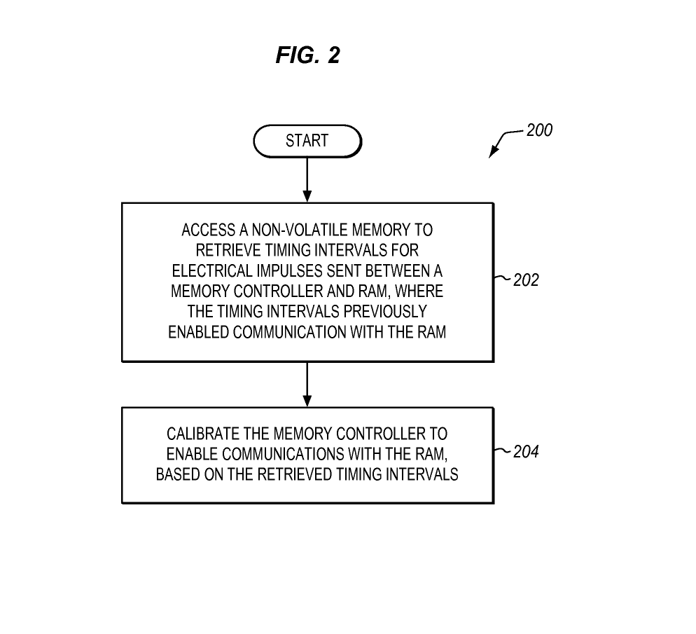

As discussed above, the timing intervals used to establish communications with RAM 140 may vary depending on the circumstances. However, the timing intervals stored in non-volatile memory 110 still represent a “best guess” as to which timing intervals should be used to establish communications when electronic device 100 re-initializes the physical layer. Therefore, using these stored values can reduce (and in some cases even remove) the time taken for gate training. Further details of the operation of electronic device 100 will be described with regard to FIG. 2 below.

FIG. 2 is a flowchart describing an exemplary method 200 to operate an electronic device to calibrate RAM. Assume, for this embodiment, that electronic device 100 has powered down some time after storing the current timing intervals (used to contact RAM 140) in non-volatile memory 110. Further, assume that electronic device 100 has just received power and is starting back up, causing management unit 120 to perform physical layer initialization (e.g., to establish communications between memory controller 130 and RAM 140).

In step 202, management unit 120 accesses non-volatile memory 110 in order to retrieve timing intervals for memory controller 130. The timing intervals describe the timing of electrical impulses sent between memory controller 130 and RAM 140. Timing intervals are any suitable read timing parameters or other timing information utilized to operate a logic gate of memory controller 130.

The timing intervals accessed by management unit 120 were previously stored in non-volatile memory 110 before electronic device 100 was shut down. Because the timing intervals were previously used successfully to establish communications between memory controller 130 and RAM 140, they can be used as a starting point for gate training in order to speed up the gate training process.

In step 204, management unit 120 calibrates memory controller 130 in order to enable communications with RAM 140. The calibration is based on the retrieved timing intervals. For example, in one embodiment management unit 120 programs registers of memory controller 130 with the retrieved timing intervals, and memory controller 130 initiates gate training using those timing intervals as starting values. Thus, if the timing intervals are still acceptable, the training process completes without cycling through different values for the timing parameters. This in turn substantially speeds up the initialization process for memory controller 130, which in turn speeds up any boot-up time associated with electronic device 100.

In one embodiment, if the retrieved timing intervals do not establish communications between memory controller 130 and RAM 140, the training process iterates by deviating from the values of one or more of the timing intervals by a specified amount. For example, the training process could increase or decrease one or more of the retrieved timing intervals by several microseconds.

Even though the steps of method 200 are described with reference to electronic device 100 of FIG. 1, method 200 may be performed in other electrical systems. The steps of the flowcharts described herein are not all inclusive and may include other steps not shown. The steps described herein may also be performed in an alternative order.

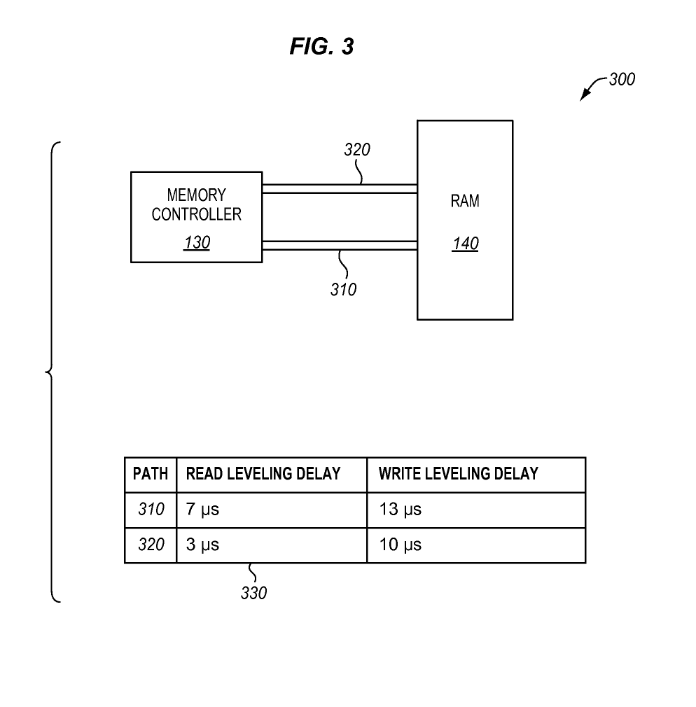

FIG. 3 is a block diagram 300 of an exemplary multi-path interface between memory controller 130 and RAM 140. In this embodiment, each path 310 and 320 comprises an electrical signaling pathway that utilizes a differential voltage between two pins in order to convey digital information. In this embodiment, timing intervals 330 are stored in non-volatile memory 110. While the specific values and nature of timing information may vary based on circuit design and other factors specific to an embodiment, timing intervals 330 indicate exemplary specific values for the circuit of FIG. 3.

Timing intervals 330 are defined for each path between memory controller 130 and RAM 140, and the timing intervals describe read leveling delays, write leveling delays, gate training parameters, and other aspects of each path. Timing intervals 330 stored in non-volatile memory 110 can be used to fill a (volatile) register memory of memory controller 130 with the appropriate values.

When gate training occurs in FIG. 3, the registers of memory controller 130 that define how to communicate along each path are filled with the values of timing intervals 330. Memory controller 130 then attempts to access RAM 140 along each pathway using the current register values for that pathway, and revises the register values if communications are not established using timing intervals 330.

### EXAMPLES

In the following examples, additional processes, systems, and methods are described in the context of a storage controller that stores gate training parameters for accessing RAM.

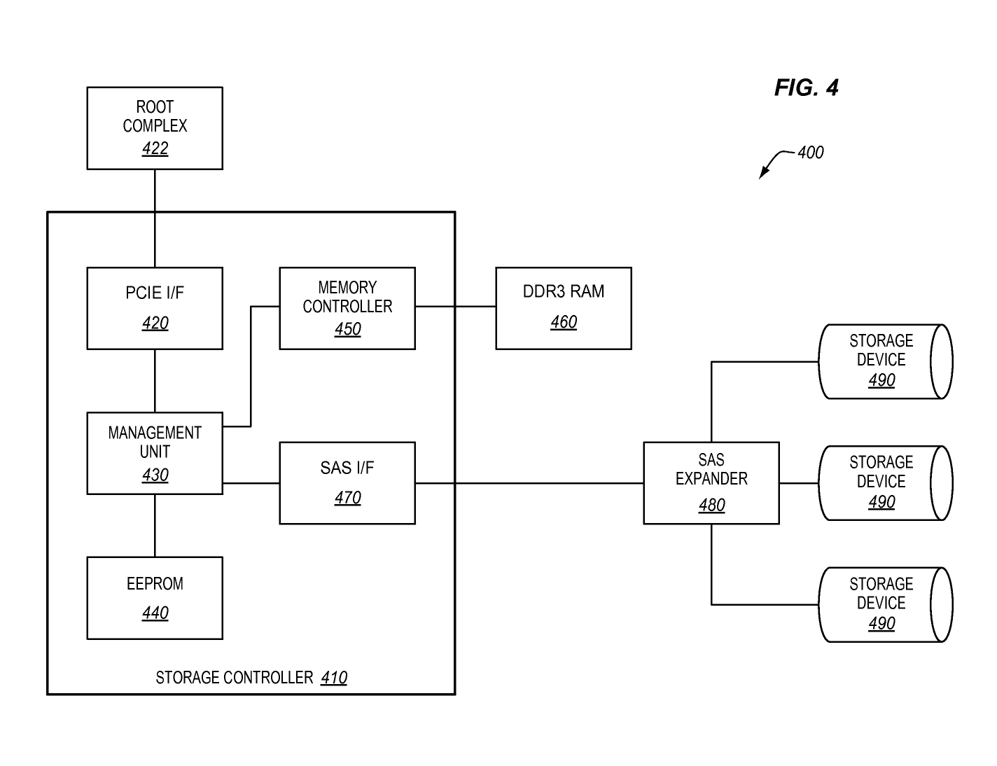

FIG. 4 is a block diagram 400 of an exemplary storage controller 410 within an exemplary storage system 400. During normal operations, storage controller 410 receives Input/Output (I/O) requests from a host via Peripheral Component Interconnect Express (PCIe) root complex 422. The I/O requests are received at PCIe interface (I/F) 420, and management unit 430 generates one or more Serial Attached Small Computer System Interface (SAS) commands at SAS I/F 470 based on the received I/O requests. The SAS commands are sent via a switched fabric (such as SAS expander 480) to retrieve and/or write data to storage devices 490, which implement the logical volume.

A switched fabric, such as the one used to contact storage devices 490, comprises any suitable combination of communication channels operable to forward/route communications for storage system 100, for example, according to protocols for one or more of Small Computer System Interface (SCSI), Serial Attached SCSI (SAS), FibreChannel, Ethernet, Internet SCSI (ISCSI), etc. In this embodiment, switched fabric comprises one or more SAS expanders 480 that link to one or more targets.

Storage devices 490 implement persistent storage capacity for storage system 400, and are capable of writing and/or reading data in a computer readable format. For example, storage devices 490 may comprise magnetic hard disks, solid state drives, optical media, etc. compliant with protocols for SAS, Serial Advanced Technology Attachment (SATA), Fibre Channel, etc.

In this embodiment, storage devices 490 implement storage space for one or more logical volumes. A logical volume comprises allocated storage space and data available via storage controller 410. A logical volume can be implemented on any number of storage devices 490 as a matter of design choice. Furthermore, storage devices 490 need not be dedicated to only one logical volume, but may also store data for a number of other logical volumes. In one embodiment, a logical volume is configured as a Redundant Array of Independent Disks (RAID) volume in order to enhance the performance and/or reliability of stored data.

In order to enhance performance, storage controller 410 utilizes RAM to cache data directed to and/or from storage devices 490. Specifically, management unit 430 operates memory controller 450 to implement a cache stored on Data Direct Rate Type Three RAM (DDR3 RAM) 460.

When storage controller 410 initializes, management unit 430 accesses Electrically Erasable Programmable Read-Only Memory (EEPROM) 440, which stores a Serial Boot Record (SBR) for storage controller 410. The SBR indicates timing intervals for memory controller 450, including one or more gate delays for memory controller 450. Management unit 430 identifies memory controller 450, and populates the registers of memory controller 450 with a value for a gate delay that was previously stored in the SBR of EEPROM 440.

Management unit 430 then starts a training process at memory controller 450 using the gate delay programmed into the registers of memory controller 450. If memory controller 450 successfully writes data to, and reads data from DDR3 RAM 460 using the programmed intervals, then memory controller 450 has been successfully initialized. Alternatively, if the present gate delay does not enable communication, management unit 430 alters the register values for the gate delay by a quarter of a clock cycle, and attempts to use memory controller 450 to establish communications again. The process of checking and revising the gate delay is an iterative process that can be performed multiple times until acceptable values are reached.

DDR3 RAM 460 can be operated at several different frequencies. Since the gate delay in this embodiment is revised based upon the clock cycle, the specific period of time (e.g., the specific number of microseconds) by which the gate delay is changed for each iteration of gate training can vary. In short, the clock value that is used to open and close the gate can be changed until the correct value is found, and this correct value does not need to be a predefined time duration. The delay values vary based on the current data transfer frequency used to communicate with DDR3 RAM 460. The higher the frequency, the shorter the duration.

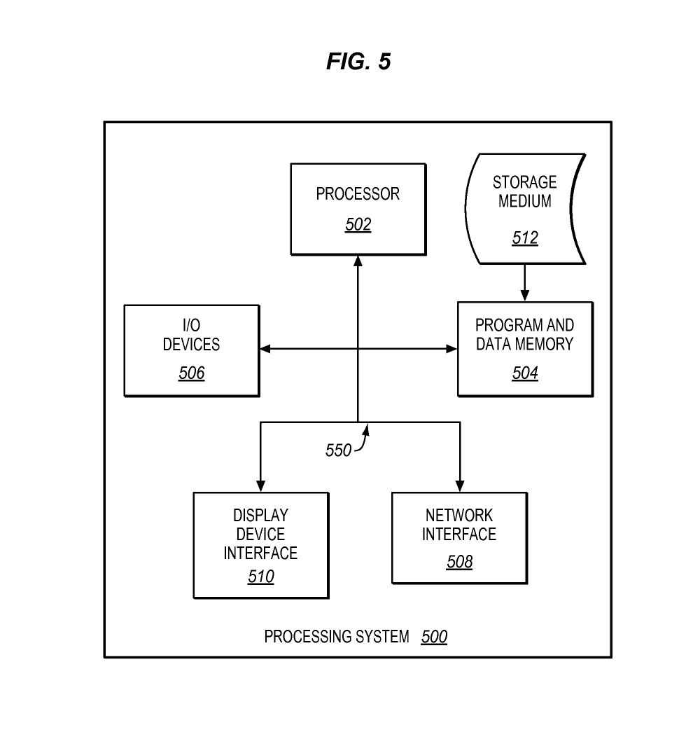

Embodiments disclosed herein can take the form of hardware, firmware, or various combinations thereof. In one particular embodiment, firmware is used to direct a processing system of management unit 120 to perform the various operations disclosed herein. FIG. 5 illustrates an exemplary processing system 500 operable to execute a computer readable medium embodying programmed instructions. Processing system 500 is operable to perform the above operations by executing programmed instructions tangibly embodied on computer readable storage medium 512. In this regard, embodiments of the invention can take the form of a computer program accessible via computer readable medium 512 providing program code for use by a computer (e.g., processing system 500) or any other instruction execution system. For the purposes of this description, computer readable storage medium 512 can be anything that can contain or store the program for use by the computer and that does not require physical level gate training.

Computer readable storage medium 512 can be an electronic, magnetic, optical, electromagnetic, infrared, or semiconductor device. Examples of computer readable storage medium 512 include a solid state memory, a read-only memory (e.g., ROM, EEPROM, etc.), etc.

Processing system 500, being suitable for storing and/or executing the program code, includes at least one processor 502 coupled to program and data memory 504 through a system bus 550. Program and data memory 504 can include local memory employed during actual execution of the program code, and cache memories that provide temporary storage of at least some program code and/or data in order to reduce the number of times the code and/or data are retrieved from bulk storage during execution.

Input/output or I/O devices 506 (including but not limited to keyboards, displays, pointing devices, etc.) can be coupled either directly or through intervening I/O controllers. Network adapter interfaces 508 may also be integrated with the system to enable processing system 500 to become coupled to other data processing systems or storage devices through intervening private or public networks. Modems, cable modems, IBM Channel attachments, SCSI, Fibre Channel, and Ethernet cards are just a few of the currently available types of network or host interface adapters. Display device interface 510 may be integrated with the system to interface to one or more display devices, such as screens for presentation of data generated by processor 502.

What is claimed is:

1. A system, comprising:
a memory controller; and
a management unit operable to initialize the system after the system returns from an unpowered state by accessing a non-volatile memory to retrieve timing intervals for electrical impulses sent between the memory controller and a Random Access Memory, wherein the timing intervals previously enabled communication between the memory controller and the Random Access Memory;
the management unit further operable to initialize the system after the system returns from an unpowered state by calibrating the memory controller to enable communication with the Random Access Memory based on the retrieved timing intervals.

2. The system of claim 1, wherein:
the management unit is further operable to calibrate the memory controller by performing an iterative training process;
during the iterative training process, the management unit determines whether the retrieved timing intervals enable communication between the memory controller and the Random Access Memory, and the management unit selects new timing intervals if the retrieved timing intervals do not enable communication with the Random Access Memory.

3. The system of claim 2, wherein:
the management unit is further operable to determine that the retrieved timing intervals do not enable communication with the Random Access Memory, and to select new timing intervals by deviating from the value of one or more of the retrieved intervals by a specified amount.

4. The system of claim 1, wherein:
the management unit further is further operable to detect an impending loss of power at the system, and to replace the timing intervals stored in the non-volatile memory with timing intervals presently used to enable communication between the memory controller and the Random Access Memory.

5. The system of claim 1, wherein:
the timing intervals define at least one parameter for the memory controller selected from gate training, read leveling delay, and write leveling delay.

6. The system of claim 1, wherein:
the timing intervals include values for each of multiple differential signaling pathways used by the memory controller to contact the Random Access Memory.

7. The system of claim 1, wherein:
the management unit is further operable to calibrate the memory controller by programming the retrieved timing intervals into hardware registers of the memory controller.

8. The system of claim 1, wherein:
the Random Access Memory comprises Double Data Rate Type Three Synchronous Dynamic Random Access Memory.

9. The system of claim 1, wherein:
the non-volatile memory comprises an Electrically Erasable Programmable Read-Only Memory.

10. A method, comprising:
initializing communications between a memory controller and a management unit after an unpowered state by:
accessing a non-volatile memory to retrieve timing intervals for electrical impulses sent between the memory controller and a Random Access Memory, where the timing intervals previously enabled communication between the memory controller and the Random Access Memory; and
calibrating the memory controller to enable communication with the Random Access Memory based on the retrieved timing intervals.

11. The method of claim 10, further comprising:
calibrating the memory controller by performing an iterative training process;
during the training process, the method further comprises:
determining whether the retrieved timing intervals enable communication with the Random Access Memory; and
selecting new timing intervals if the retrieved timing intervals do not enable communication with the Random Access Memory.

12. The method of claim 11, further comprising:
determining that the retrieved timing intervals do not enable communication with the Random Access Memory; and
selecting new timing intervals by deviating from the value of one or more of the retrieved intervals by a specified amount.

13. The method of claim 10, further comprising:
detecting an impending loss of power at the system; and
replacing the timing intervals stored in the non-volatile memory with timing intervals presently used to enable communication between the memory controller and the Random Access Memory.

14. The method of claim 10, wherein:
the timing intervals define at least one parameter for the memory controller selected from gate training, read leveling delay, and write leveling delay.

15. The method of claim 10, wherein:
the timing intervals include values for each of multiple differential signaling pathways used by the memory controller to contact the Random Access Memory.

16. The method of claim 10, further comprising:
calibrating the memory controller by programming the retrieved timing intervals into hardware registers of the memory controller.

17. The method of claim 10, wherein:
the Random Access Memory comprises Double Data Rate Type Three Synchronous Dynamic Random Access Memory.

18. The method of claim 10, wherein:
the non-volatile memory comprises an Electrically Erasable Programmable Read-Only Memory.

19. A storage controller, comprising:
a memory controller; and
a management unit operable responsive to the system returning from an unpowered state to read timing intervals from a Serial Boot Record of an Electrically Erasable Programmable Read-Only Memory, wherein the timing intervals were previously used to establish communications between the memory controller and a Random Access Memory;
the management unit further operable responsive to the system returning from an unpowered state to program the retrieved timing intervals into hardware registers of the memory controller;
the memory controller operable to read the registers to identify the timing intervals, and to use the timing intervals to generate electrical signals that are directed to the Random Access Memory; and
the management unit further operable to determine whether communication has been established between the memory controller and the Random Access Memory, and to alter the timing intervals at the hardware registers of the memory controller if communication has not been established.

20. The storage controller of claim 19, wherein:
the management unit is further operable to iteratively determine whether communication has been established and alter the timing intervals at the hardware registers of the memory controller if communication has not been established
